(19) United States
(12) Patent Application Publication
(10) Pub. No.: US 2008/0032028 A1
(43) Pub. Date: Feb. 7, 2008

(54) Succulent snacks

(76) Inventor: Rameshchandra M. Gohil, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/504,239

(22) Filed: Aug. 15, 2006

(51) Int. Cl. A23L 1/05

(52) U.S. Cl. 426/573

(57) ABSTRACT

A process is disclosed that can be used for manufacturing a succulent product comprising combining a thickening or wheying preventing agent with a fluid food to produce a thickened fluid food; combining, with optional mixing, the thickened fluid food with a metal salt to produce a salt-containing fluid food; pouring the salt-containing fluid food above 20° C. into a porous container capable of releasing the salt-containing fluid food to produce one or more droplets; and combining the droplet with a food grade polymer solution or dispersion to produce a droplet having coated thereon the polymer made it water resistant by salt solution.

The invention relates to succulent snacks from dairy and other liquid products and process therefor.

Succulent products generally have a water activity greater than 0.90. This is similar to food items such as peach, strawberry, or yogurt.

Grapes, cherry tomatoes, or orange sections are examples having liquids contained and protected by a barrier material which also provides structural integrity. Unfortunately these are not shelf stable and require refrigeration.

Apples or oranges are not convenient to eat in the car, on the go, or in children's lunches. For the school lunch segment, applesauce in a container is “more fun”, and has a higher probability of being consumed, but the packaging is not convenient for either car consumption or grab and go. In all cases, spoons are logistically and psychologically problematic. Processed fruits (applesauce, pears, etc.) in a bite sized, edible, dry to the touch form may be combined with additional widely recognized nutritious ingredients such as fiber, soy, etc.

Creating edible balls with polysaccharide skin containing solids and juice (water activity greater than 0.9) food products is not new and efforts in this direction were started as early as 1972. See e.g., U.S. Pat. Nos. 2,909,435; 4,507,327; 4,119,739; 3,922,360; and 4,117,172 and EP 1,378,173.

Processed snack foods sold today, such as the convenience driven market segments including dash board dining, lunch box, and grab and go, make the consumers thirsty.

There is a continuing need for snack foods that could quench thirst and also provide taste, nutrition, convenience, better mouth feel, aroma, juiciness, pleasing texture, aesthetic appearance, etc. For example, an edible material with enough significant structural integrity to hold “liquids” could be used to create a new category of thirst quenching snacks and people are becoming health conscious such as an increasing interest in yogurt-based products, both in young and old generations.

### SUMMARY OF THE INVENTION

The invention provides a succulent product comprising or produced from a thickening agent such as an edible polymer (e.g., carrageenan) and a fluid food.

A process that can be used for manufacturing a succulent product comprises combining a thickening agent or wheying preventing agent with a fluid food to produce a thickened fluid food; combining, with optional mixing, the thickened fluid food with a metal salt to produce a salt-containing fluid food; pouring the salt-containing fluid food above 20° C. into a porous container capable of releasing the salt-containing fluid food to produce one or more droplets; and combining the droplet with a food grade polymer solution or dispersion to produce a droplet having coated thereon the polymer.

### DETAILED DESCRIPTION OF THE INVENTION

The term fluid food means a food product that is liquid, semi-liquid, or semi-solid and can include yogurt, soymilk, cheese, creamy cheese, pudding, jam, jelly, fruit juice, chocolate, sour cream, or combinations of two or more thereof.

The invention also includes a substantially spherical product having coated thereon a polymer wherein the product and polymer are the same as those disclosed above and can be made by the process disclosed above.

The product can be produced by any known processes known to one skilled in the art. It can be produced by the process disclosed above.

To maintain a desired shape such as round or other shapes, the viscosity of fluid food or blend of fluid food at, for example, room temperature (about 25° C.) can be adjusted by, for example, combining with an effective amount of thickener. Wishing not to be bound by theory, the thickening can be, for example, crosslinking of the fluid food. Any thickener can be used. For food product, only food grad thickener is recommended. Examples of thickeners include carrageenan, an alginate such as sodium alginate or alginate having high content of guluronic acid residue which optionally neutralized or partially neutralized with one or more divalent metal salts, xanthan gum, pectin, low methoxy pectin, sugar (e.g., sucrose or fructose), gelatin, locust bean gum, tapioca gum, corn starch, arrowroot, or combinations of two or more thereof.

Carrageenan is a colloid extracted from various Carrageenan seaweed and other red algae such as Irish moss and used as a suspending agent (e.g., as in foods) and as a clarifying agent (e.g., as for beverages) and in controlling crystal growth in frozen confections. Carrageenan aqueous solution is in liquid form above 70° C. and solidifies on cooling. Its ability to form thick solution or gel varies with different types of Carrageenans. For example, Iota forms elastic gel with calcium salt, kappa forms strong rigid gel with potassium salt but brittle with calcium salt and the gel become clear in the presence of sugar and lambda form does not form gel but forms high viscosity solution. Physically crosslinked alginates and pectins are insoluble in water and change taste and mouth feel. On the other hand, carrageenan or its blend of different forms or with other thickener(s) may solidify fluid food or mixture of fluid food and thickening agent at room temperature, even at low concentration in water (e.g., <2%, 1%, or 0.6%) and does not require physical crosslinking. However, with use of Carrageenan manufacturing process has to be carried out above solidifying temperature (about 20-120 or about 30-100° C.).

Other thickening agents disclosed above are well known to one skilled in the art and the description of which is omitted hereinfor the interest of brevity.

Combining a thickener with fluid food can be carried out under any conditions effective to adjust the viscosity of the fluid food to a desirable level. The combining can be aided with a proper mixing such as agitation or other mechanical mixing. A desirable viscosity can depend on individuals' preferences and can be adjusted in such fashion so that on cutting the core of the product solidified fluid food or their physical forms does not substantially flow or spill out at room temperature. Thickening is a process for increasing viscosity of original products. We are teaching that we adjust viscosity in such a fashion so that on cutting ball content does not flow. The condition can include an ambient temperature or an elevated temperature such as from about 10 to about 150° C., about 20 to about 120° C., or about 30 to about 100° C. such as about 65° C., under an atmospheric pressure or an elevated pressure that accommodates the temperature range, for a sufficient time to archive the desired viscosity such as from about 10 seconds to about 5 hours.

For example, when carrying out the process above 30° C., some food products such as yogurt-base products, can degrade and change viscosity, taste and texture. To prevent the degradation on heating, a flour such as gram flour (made from roasted grams), starch, precooked potato starch, cornstarch, or combinations of two or more thereof can be added to the food product. The flour can maintain the taste and texture and allow one to pasteurize the food product. Alternatively, one or more thickening agents can be combine with the flour additive to provide better texture, reduce water activity, or protect the food from degrading.

Viscosity of a polysaccharide can also be adjusted by controlling pH of the content containing the polysaccharide. Addition of sugar as dispersing agent may allow achieving more fully dispersion and lowering water activity. Addition of more than 10% sugar may not alter viscosity appreciably.

Optionally a thickened fluid food can be combined, with an optional mixing, with a metal salt under a condition, and mixing, similar to or the same as those disclosed above. Examples of metal salts include lactate, citrate, saccharin, acetate, propionate, butyrate, or combinations of two or more thereof and the metals include calcium, magnesium, potassium, sodium, or combinations of two or more. The metal salt content in the fluid food can be in the range of from about 0.00001 to about 10%, about 0.0001 to about 5%, about 0.0001 to about 1%, or about 0.0001 to about 0.5% (by weight). For example, pectin or sodium alginate when blended with a calcium compound may produce a gel that is water insoluble and may take longer for the insoluble product to dissolve in the mouth and may change the taste.

The thickened fluid food is generally regarded as being pasteurized because it is formed at elevated temperature. If desire, it can be further pasteurized by any means known to one skilled in the art and transferred to a container.

Any porous containers containing a loose frame with suitable shapes and/or sizes can be used, depending on the shape and size of the droplets desired. The diameter of the droplets can be from about 0.01 to about 10, about 0.1 to about 8, about 0.5 to about 6, or about 1 to about 5, cm. Any container having a plurality of passages or holes with desired diameters can be used such as sieves, bottles, flasks, jars, tanks, baskets, or tray (e.g., ice cube tray makes cubes). The passage of fluid food through the passages or holes can be instant or delayed depending on the size desired and the viscosity of the food. A container can be made of metal, polymer or ceramics.

Pouring a fluid food above solidifying temperature (a temperature at which fluid does not substantially flow) using conventional technology into, for example, either a polysaccharide solution in a porous container capable of making desired shapes of solidified mixture at room temperature and releasing a shaped solidified product to food grade polymer solution or dispersion which can be then treated with, for example, a divalent metal salt solution to produce water insoluble skin around the thickened foods.

The droplets, having sizes depending on the passages disclosed above, can be collected in a second container including a solution or dispersion that comprises about 0.1 to about 25, such as about 1 to about 10 weight % of one or more polymer or gum, generally a polysaccharide. Alternatively, the droplets can be dipped into such solution or dispersion. The droplet thus collected can be submerged in the solution or dispersion for a period of time such as 1 second to 1 hour, about 10 seconds to about 30 minutes, or about 1 to about 20 minutes. The solution or dispersion can contain sucrose. Wishing not to be bound by theory, such period of time allows metal cations such as Ca⁺² diffuse into and, possibly bind to, the polymer thereby forming a water-insoluble coating or film (or wrap or skin) of appropriate thickness on the droplets. Appropriate thickness can include about 0.0001 to about 2 mm. The procedure can be repeated if the coating or film is too thin to be desirable. Solidified thin sheets of fluid food can be cut into suitable shapes.

Though a number of polysaccharides can be used, food grade polymers are used for preparing the invention products. Such polymers can be edible natural polymer, GRAS (generally regarded as safe) material, neutral taste, good transparency, high mechanical properties, fairly good oxygen and water barrier, high tendency for gelation and/or ability to crosslink with, for example, one or more divalent metal ions. Also, a polymer blend can be designed so that the mixing of two polymers can lead to formation of insoluble blends. Example of food grade polymers include such as metal alginate where the metal can be sodium, potassium, or both, xanthan gums, food grade gums, or combinations of two or more thereof. The solution or dispersion can contain 0.1 to about 20%, about 0.5 to about 15%, about 1 to about 10%, or about 3 to about 10% (by weight) of the polymer. The solution or dispersion can further comprise additives such as food grade carbohydrate (e.g., pectin), juice, nuts or powder thereof, food dyes, anti-microbial agents, microcrystalline cellulose, fibers, preservatives, texture improvers (to enhance mouth feel), flavor or aroma enhancers, UV stabilizers, light stabilizers, antioxidant, oxygen barriers, water barriers, or combinations of two or more thereof. The additive may increase shelf-life, taste, texture, etc.

Thereafter, the product can be placed in or washed with water to remove excess unused or unreacted polymer and the products can be transferred to a separate container for refrigeration, storage, or direct consumption.

Optionally, the products can be further coated or encapsulated with a coating or encapsulating solution or dispersion about 0.1 to about 15 or about 0.6 to about 8 weight % of carrageenan colloid, gelatin colloid, lipids or blend of lipids, wax, sugar syrup, chocolate, or water barrier resins to further enhance water or oxygen barrier, to increase the shelf life, or to resist puncture. If the product desires a high water barrier, the shaped product can be coated with lipids or lipid blends, blends of suitable wax, sugar syrup, chocolate or other appropriate materials. The solution or dispersion can contain one or more additives including starch, gum, sugars, cream of tartar, coloring additives, and spices to enhance the taste.

Any suitable technique can be used to encapsulate shaped product such as spraying, blushing, dipping, pouring, or combinations of two or more thereof. For example, carrageenan is in solid form at room temperature so encapsulation can be done above room temperature.

Juicy products in the form of edible tubes or spaghetti can also be made with the process disclosed.

### EXAMPLE 1

In 20 g water, 1 g of carrageenan was added and heated till became clear solution. 4 g of gram flour (Basen) was mixed with 96 g of plain yogurt and added to carrageenan solution. The content was then mixed using Braun stick mixture and heated to 70° C. to get uniform solution. Yogurt mixture containing gram flour and carrageenan was then poured in an aluminum pan containing round cavity. The content immediately took the form of small hemispheres (2.5×1 cm) balls. They were then dipped in 2% solution of sodium alginate containing 2% sucrose and than treated with 2% calcium chloride solution. Balls were then washed with water and refrigerated. On cutting the cylinder, the content did not flow and had resemblance similar to the texture of grapes.

On cutting the balls, the content did not flow, no release of liquid, resemblance similar to the texture and shapes of grapes.

### EXAMPLE 2

4 g Agro (corn) starch was dissolved in 10 g of water. In a separate container, 1 g of carrageenan was dissolved in 20 g water. Both contents were mixed at 70° C. and then 96 g plain yogurt (225 g yogurt has 14 g sugar) was added and mixed using Braun stick mixture. Content was thick so 10 g additional water was added and heated to reach temperature of 70° C. Slurry so made was in a liquid form and poured to mold having cylindrical cavities. The content immediately took the form of small cylinders (1.5×1.5 cm). They were then dipped in 3% solution of sodium alginate containing 2% sugar and than treated with 3% calcium chloride solution. Cylinders then washed with water and refrigerated. On cutting the cylinder, the content did not flow, no release of liquid and had resemblance similar to the texture of grapes.

### EXAMPLE 3

The run was carried the same as Example 2 except that 4 g of sugar was added to the corn starch and 10 g water. On cutting the cylinder, the content did not flow and had resemblance similar to the texture of grapes.

### EXAMPLE 4

The run was carried the same as Example 2 except that 99 g of Dannon Blueberry fruit yogurt containing pectin and other ingredients (sugar, fructose syrup, modified corn starch, kosher gelatin, malic acid, disodium phosphate, carmine, vitamin 12, etc.) purchased at a local supermarket was used, that the mixed content was heated to reach temperature of 72° C., and that the small cylinders were dipped in 5% solution of sodium alginate containing 2% sugar and then treated with 3% calcium chloride solution. On cutting the cylinder, the content did not flow, water did not release from cylinders and had resemblance similar to the texture of grapes.

### EXAMPLE 5

First, a mixture of 8 g of Oetker clear glaze, 0.05 g of calcium lactate and 4 g sugar in 115 g of water was heated to 70° C., adding 93 ml of Danimals liquid yogurt, followed by stirring till it became uniform. The whole content was cooled to about 25° C. to about 2 to 2.5 cm diameter balls and smashed. The balls were dipped in 5% sodium alginate solution followed by washing with water to remove excess sodium alginate, and dipping into 5% calcium chloride solution. Texture was similar to grapes. Aspect ratio (diameter to height) of ball changed from 1 to 1.6.

Liquid solution was made from Dr. Oetker red glaze according to the instruction and poured into shallow vessel to get thickness of ¼ of ball diameter. Solution was cooled to about 25° C. to form solid gel-like structure. The balls were placed on the gel-like structure. Again the liquid solution made from Dr. Oetker red glaze was poured to cover the balls. The content with encapsulated balls was cooled to about 25° C. and then cut in bite size pieces. These pieces were also coated with sodium alginate and calcium solution as described above and refrigerated.

### EXAMPLE 6

A mixture of 50 g Smucker's Concord Grape Jelly containing grape, high fructose corn syrup, fruit pectin and citric acid and a solution containing 0.5 g carrageenan and 2 g Agro starch in 20 g water was made by heating to 75° C. (or 70 to 75° C. range) was blended using Braun stick mixture. Slurry so made was in a liquid form and poured to mold having cylindrical, hemisphere and rectangular cavities. The content immediately took the form of small cylinders (1.5×1.5 cm) and dipped in 5% solution of sodium alginate containing 2% sugar and than treated with 5% calcium chloride solution. Cylinders were then washed with water and refrigerated. On cutting the cylinder, the content did not flow; water did not release from balls or cylinder and had resemblance similar to the texture of grapes.

### COMPARATIVE EXAMPLE 1

Contents of three containers containing 0.6% solution of sodium alginate, pectin, and carrageenan, respectively, were heated to 75° C. and allowed them to cool down to room temperature (about 25° C. or about 23 to 25° C.). Carrageenan solution formed solid gel-like structure while pectin and sodium alginate remained in solution state. These results indicate that even using low concentration of carrageenan one can adjusted the firmness of the products.

### COMPARATIVE EXAMPLE 2

Three solutions were made in 15 g water and 25 g plain yogurt. The first contained 0.5 g gram flour; the second contained 0.5 g Agro starch; and the third contained no additional additive. Each was heated to 85° C. The first and the second remained uniformly mixed, but the yogurt and watery liquid separated out in the third one suggesting that flour and/or starch did not allow yogurt to spoil or change its texture and taste on heating.

### COMPARATIVE EXAMPLE 3

Here we took upper part of Dannon Blueberry fruit yogurt, i.e., plain yogurt without fruit (25 g) disclosed in Example 4 was added 0.05 g Calcium lactate and 2 to 2.5 cm diameter balls were made as in Example 4 except that the balls were dipped in 5% sodium alginate solution, washed with water to remove excess sodium alginate, and followed by dipping into 5% calcium chloride solution. Balls so made were soft and changed the aspect ratio to 2.6-3. The balls released 30% of water.

### COMPARATIVE EXAMPLE 4

The run was the same as Example 2 except that 4 g corn starch and 4 g sugar were used, 1 g of pectin was used in place of carrageenan, and 92 g instead of 96 g yogurt was used. The content remained in liquid-like (it flowed and did not retain the shape of mold after removing from mold) state at room temperature. The result shows that previously established formulation containing pectin and calcium salt was not desirable.

### COMPARATIVE EXAMPLE 5

The run was carried out as Example 4 except that 25 g of Dannon Blueberry fruit yogurt was added 0.05 g Calcium lactate; about 2 to 2.5 cm diameter balls were made; and the balls were dipped into 5% calcium chloride (CaCl2 was used remove calcium saccharin) solution. The balls were soft and changed the aspect ratio from 1 to 3.3 and released 25% of water.

### COMPARATIVE EXAMPLE 6

The run was the same as Comparative Example 6 except that plain yogurt was used. Balls so made were hard having deformed shapes.

### EXAMPLE 7

First, a mixture of 8 g of Oetker clear glaze, and 4 g sugar in 70 g of water was heated to 70° C., adding 50 ml of 8^{th} continent soymilk liquid and 50 g yogurt, followed by stirring till it became uniform. The whole content which was at 70° C. was poured in mold. The balls were removed and dipped in 5% sodium alginate solution followed by washing with water to remove excess sodium alginate, and dipping into 3% calcium chloride solution. Texture was similar to grapes.

### EXAMPLE 8

The example was the same as Example 7 except 10 g of Oetker clear glaze, and 50 g water, and 00 ml of 8^{th} continent soymilk liquid were used.

### EXAMPLE 9

A mixture containing soy yogurt (100 g Senja au soja; Chocolate flavor) which contained soya extract, sugar, chocolate powder, modified starch, xanthane gum, salt, and calcium phosphate, Oetker clear glaze (10 g), and water (80 g) was heated to 70° C., stirred till it became uniform. The whole content at 70° C. was poured in a mold having ball shapes. The balls were removed and dipped in 5% sodium alginate solution followed by washing with water to remove excess sodium alginate, and dipping into 3% calcium chloride solution. Texture was similar to grapes.

1. A succulent product comprising or produced from thickening agent, a fluid food, and optionally a calcium salt wherein the thickening agent includes carrageenan, alginate, xanthan gum, pectin, low methoxy pectin, sugar (e.g., sucrose or fructose), gelatin, locust bean gum, tapioca gum, corn starch, arrowroot, or combinations of two or more thereof and the fluid food includes yogurt, soymilk, creamy cheese, pudding, jam, jelly, fruit juice, chocolate, sour cream, or combinations of two or more thereof.

2. The product of claim 1 wherein the thickening agent is carrageenan, alginate, or combinations thereof and the alginate is sodium alginate or an alginate having high content of guluronic acid residue which optionally neutralized or partially neutralized with one or more divalent metal salts.

3. The product of claim 1 wherein the thickening agent is carrageenan.

4. The product of claim 1 wherein the fluid food is yogurt, soymilk, or combinations thereof and the product comprises the calcium salt.

5. The product of claim 2 wherein the fluid food is yogurt, soymilk, or combinations thereof and the product comprises the calcium salt.

6. The product of claim 3 wherein the fluid food is yogurt, soymilk, or combinations thereof and the product comprises the calcium salt.

7. The product of claim 6 wherein the fluid food is yogurt.

8. The product of claim 6 wherein the fluid food is soymilk.

9. A substantially spherical product having coated thereon a polymer wherein the polymer includes carrageenan, alginate, xanthan gum, pectin, low methoxy pectin, sugar (e.g., sucrose or fructose), gelatin, locust bean gum, tapioca gum, corn starch, arrowroot, or combinations of two or more thereof and the product is a fluid food including yogurt, soymilk, creamy cheese, pudding, jam, jelly, fruit juice, chocolate, sour cream, or combinations of two or more thereof.

10. The product of claim 9 wherein the polymer is carrageenan, alginate, or combinations thereof and the alginate is sodium alginate or an alginate having high content of guluronic acid residue which optionally neutralized or partially neutralized with one or more divalent metal salts.

11. The product of claim 10 wherein the polymer is carrageenan,

12. The product of claim 11 wherein the fluid food is yogurt, soymilk, or combinations thereof and the product comprises the calcium salt.

13. The product of claim 12 wherein the fluid food is yogurt.

14. The product of claim 12 wherein the fluid food is soymilk.

15. A process comprising combining a thickening agent to a fluid food to produce a thickened fluid food; combining, with optional mixing, the thickened fluid food with a metal salt to produce a salt-containing fluid food; transferring the salt-containing fluid food into a porous container capable of releasing the salt-containing fluid food to produce one or more droplets; and combining the droplet with a food grade polymer solution or dispersion to produce a droplet having coated thereon the polymer made it water resistant by salt solution.

16. The process of claim 15 wherein the thickening agent includes carrageenan, alginate, xanthan gum, pectin, low methoxy pectin, sugar (e.g., sucrose or fructose), gelatin, locust bean gum, tapioca gum, corn starch, arrowroot, or combinations of two or more thereof and the fluid food includes yogurt, soymilk, creamy cheese, pudding, jam, jelly, fruit juice, chocolate, sour cream, or combinations of two or more thereof.

17. The process of claim 16 wherein the thickening agent is carrageenan, alginate, or combinations thereof and the alginate is sodium alginate or an alginate having high content of guluronic acid residue which optionally neutralized or partially neutralized with one or more divalent metal salts.

18. The process of claim 16 wherein the thickening agent is carrageenan.

19. The process of claim 17 wherein the fluid food is yogurt, soymilk, or combinations thereof and the product comprises the calcium salt.

20. The process of claim 19 wherein the product is water resistant.
